(19) United States
(12) Patent Application Publication
(10) Pub. No.: US 2024/0336149 A1
(43) Pub. Date: Oct. 10, 2024

(54) BODY-IN-WHITE (BIW) INTEGRATED BATTERY FRAME

(71) Applicants: Miguel MERINO, Sterling Heights, MI (US); Venugopal GARIMELLA, Troy, MI (US); MAGNA INTERNATIONAL INC., Aurora (CA)

(72) Inventors: Miguel MERINO, Sterling Heights, MI (US); Venugopal GARIMELLA, Troy, MI (US)

(21) Appl. No.: 18/293,827

(22) PCT Filed: Aug. 3, 2022
(86) PCT No.: PCT/US2022/039300

§ 371 Date: Jan. 31, 2024

Related U.S. Application Data
(60) Provisional application No. 63/229,282, filed on Aug. 4, 2021.

(51) Int. Cl. B60L 50/64; B60K 1/04; B62D 25/20; B62D 27/06

(52) U.S. Cl. CPC B60L 50/64; B60K 1/04; B62D 25/2036; B62D 27/065; B60K 2001/0438

(57) ABSTRACT

A body-in-white (BIW) of an electric vehicle includes an integrated battery frame having an integrated cover and a lower tray that may be joined together for holding a battery pack for powering the EV. The integrated battery frame extends between and connects to each of two opposite rocker panels of the BIW and provides a floor of the vehicle for mounting cabin components/assemblies such as passenger seats. The integrated battery frame also functions to enclose a battery compartment for protecting batteries from water intrusion and crash events. The integrated battery frame and BIW of the present disclosure provides an efficient EV architecture that eliminates redundant structures and components, improves load paths, and increases space for batteries.

### CROSS REFERENCE TO RELATED APPLICATIONS

This PCT international patent application claims the benefit of U.S. Provisional Patent Application No. 63/229,282, filed Aug. 4, 2021, the contents of which is incorporated herein by reference in its entirety.

### FIELD

The present disclosure relates generally to a battery frame. More specifically, the present disclosure relates to a battery frame for an electrified vehicle that is integrated with a body-in-white of the electrified vehicle.

### BACKGROUND

Electrified vehicles, such as such as battery electric vehicles (EVs) and plug-in hybrid electric vehicles (PHEVs), rely upon batteries to store electrical energy. Packing of batteries within such electrified vehicles requires a number of design considerations, including weight distribution, temperature regulation, and serviceability.

There is a large and growing market for electric vehicles, and particularly for electric vehicles having batteries that are configured to be serviceable without requiring an entire conventional battery pack to be removed from the vehicle, which may require special equipment and/or training due to the size and weight of conventional battery packs.

Motor vehicles typically include a body structure formed by joining one or more pieces, for example by welding. Body in white (BIW) is a stage in vehicle manufacturing in which the pieces of the body structure have been joined together, before painting and before components, such as a motor or engine, chassis sub-assemblies, and/or trim have been attached to the body structure.

### SUMMARY

The present disclosure provides a body structure of a motor vehicle. The body structure comprises an integrated cover including an upper panel surrounded by an upper peripheral wall to define a battery compartment for holding a battery pack. The upper panel defines a floor of the vehicle. The body structure also comprises a lower tray selectively attached to the integrated cover to enclose the battery compartment. The lower tray includes a lower panel that extends parallel to the upper panel of the integrated cover.

The present disclosure also provides a battery frame for a vehicle. The battery frame comprises an integrated cover that includes an upper panel surrounded by an upper peripheral wall to define a battery compartment for holding a battery pack. The battery frame also comprises a lower tray that is selectively attached to the integrated cover to enclose the battery compartment. The lower tray includes a lower panel that extends parallel to the upper panel of the integrated cover. The upper panel of the integrated cover is configured to connect to and span between each of two opposite rocker panels of the vehicle and to provide a load path therebetween.

### BRIEF DESCRIPTION OF THE DRAWINGS

Further details, features and advantages of designs of the invention result from the following description of embodiment examples in reference to the associated drawings, in which a battery frame is disclosed.

FIG. 1 is a partially exploded perspective view of a body-in-white (BIW) with an integrated battery frame in accordance with an aspect of the disclosure.

FIG. 2 shows a view of the BIW with an integrated cover from below, looking upward, in accordance with an aspect of the disclosure.

FIG. 3 is an exploded side view of the BIW with the integrated battery frame in accordance with an aspect of the disclosure.

FIG. 4 is an exploded perspective view of the BIW with the integrated battery frame in accordance with an aspect of the disclosure.

FIG. 5A is a cross-sectional view of the BIW with the integrated battery frame before assembly, in accordance with an aspect of the disclosure.

FIG. 5B is a cross-sectional view of the BIW with the integrated battery frame in an assembled configuration, in accordance with an aspect of the disclosure.

### DETAILED DESCRIPTION

Recurring features are marked with identical reference numerals in the figures, in which example embodiments of a body-in-white (BIW) with an integrated battery frame are disclosed.

Motor vehicles, such as passenger cars and trucks, typically include a body structure formed by joining one or more pieces, for example by welding. The pieces of the body may be formed from metal, which may be formed to a particular shape, for example, by pressing, casting, machining, trimming, etc. Body in white (BIW) is a stage in vehicle manufacturing in which the pieces of the body structure have been joined together, before painting and before components, such as a motor or engine, chassis sub-assemblies, and/or trim have been attached to the body structure.

Current electric vehicles (EV) architectures have evolved from traditional internal-combustion engine (ICE) vehicle architectures. Thus, they have not yet been completely optimized. These EV architectures have many redundant structures and components in BIWs and Battery trays to manage crash-load and sealing requirements. The load-paths may also not have been optimized for EV-specific configurations. Therefore, current EV architectures have less space for batteries, excess components, and unnecessary mass.

It is an objective of the present disclosure to provide an integrated battery frame structure and BIW. It is also an objective of the present disclosure to eliminate redundant structure from Electric Vehicles, and to increase the density of battery cells. In accordance with an aspect of the disclosure, the BIW may provide protection to the battery cells.

The present disclosure provides an integrated battery frame structure and BIW in which Battery Frame structural components are directly integrated to the BIW to provide improved performance for front/side/rear crash protection. The integrated battery frame structure and BIW of the present disclosure may eliminate redundant structure by integrating it to the BIW and improve the load transfer.

The integrated battery frame structure and BIW of the present disclosure provides an efficient EV architecture that eliminates redundant structures and components, improves load paths, and increases space for more batteries. The BIW alone takes crash load from both passenger and battery safety requirements. The BIW integrated battery frame includes an integrated cover that functions as a platform for attaching cabin components/assemblies such as passenger seats, and connects rockers of the vehicle from side to side, thus providing a load path during crash events. The integrated cover also functions to enclose a battery compartment for protecting batteries from water intrusion and crash events. The integrated battery frame structure and BIW of the present disclosure may provide 15% or more additional space for batteries when compared with conventional EV architectures.

The integrated battery frame structure and BIW of the present disclosure may is much simplified when compared with conventional EV architectures and handles stiffness and durability load cases. It may provide attachments for battery cells/modules, electronic devices, electric harnesses, cooling systems, etc., promoting easy installation and service. According to an aspect of the disclosure, the battery tray may be bolted and sealed with the BIW. The integrated battery frame structure and BIW of the present disclosure may also accommodate structural batteries.

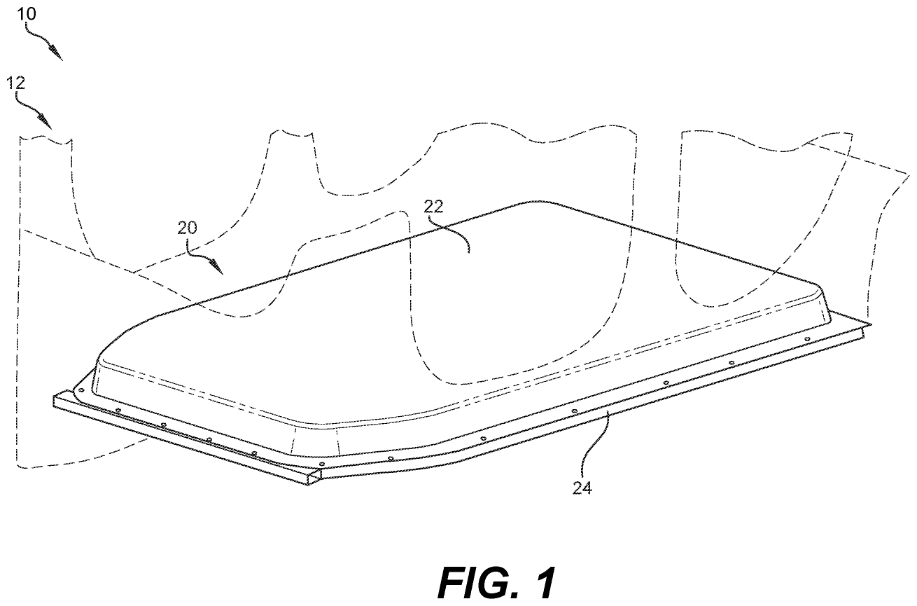

FIG. 1 is a partially exploded perspective view of a body-in-white (BIW) 10 with an integrated battery frame 20 in accordance with an aspect of the disclosure. The BIW 10 includes components 12 of the body structure, such as pillar assemblies, rocker panel assemblies, etc. The integrated battery frame 20 includes an integrated cover 22 and a lower tray 24 that may be joined together for holding a battery pack for powering the EV.

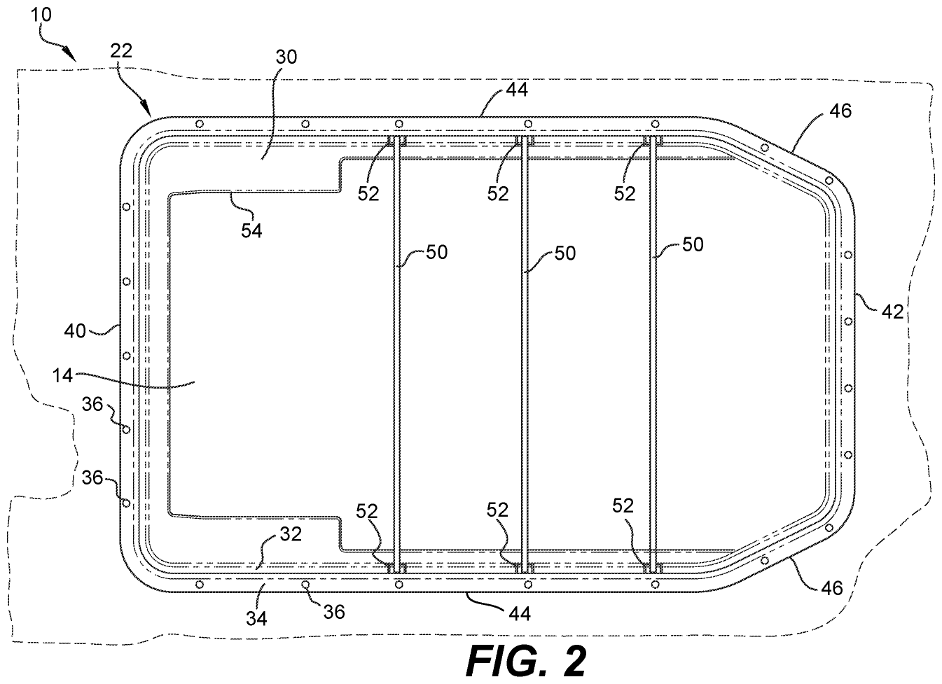

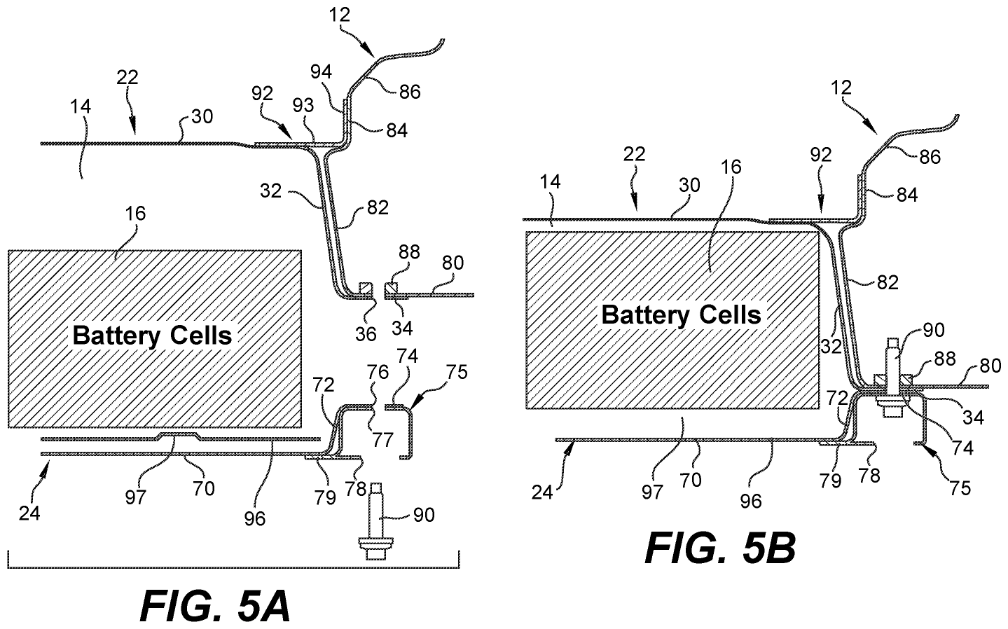

FIG. 2 shows a view of the BIW 10 with the integrated cover 22 from below, looking upward. As shown in FIG. 2, the integrated cover 22 includes an upper panel 30 surrounded by an upper peripheral wall 32 to define a battery compartment 14. The upper panel 30 may enclose a bottom of the BIW 10 and define a floor of the vehicle. The upper peripheral wall 32 may extend perpendicular to the upper panel 30. In some embodiments, and as shown in FIGS. 5A-5B, the upper peripheral wall 32 may be substantially perpendicular to the upper panel 30 and angled outwardly. The integrated cover 22 also includes an upper peripheral flange 34 extending outwardly from the upper peripheral wall 32 parallel to and spaced apart from the upper panel 30. The upper peripheral flange 34 defines a plurality of first mounting holes 36, which may be spaced apart from one another along the entirety of the upper peripheral flange 34. The integrated cover 22 has a generally rectangular shape extending between a rear edge 40 and a forward edge 42 that is parallel to and spaced apart from therefrom. The integrated cover 22 also extends between two side edges 44 that extend parallel to one another The integrated cover 22 also includes two front-corner edges 46 that extend between the forward edge 42 and corresponding ones of the side edges 44, thus providing space to accommodate packaging requirements, such as to prevent interference with front suspension components of the vehicle. In other words, the forward edge 42 may be shorter than the rear edge 40, and the difference in lengths may be bridged by the two front-corner edges 46, which each taper inwardly from corresponding ones of the side edges 44.

As shown in FIG. 2, the integrated cover 22 also includes three reinforcement rails 50 that are integrally formed in the upper panel 30 and which extend parallel to one another, between and perpendicular to the two side edges 44. End supports 52 join each of the reinforcement rails 50 to the upper peripheral wall 32 at the two side edges 44 for distributing loads therebetween. It should be appreciated that this is merely an example construction, and the number and positioning of the reinforcement rails 50 may be different, and may be based on the specific requirements of a particular vehicle application. The upper panel 30 also includes one or more bend lines 54 which may provide additional structural rigidity. The bend lines 54 may also provide clearance to accommodate battery cells or other components within the battery compartment 14.

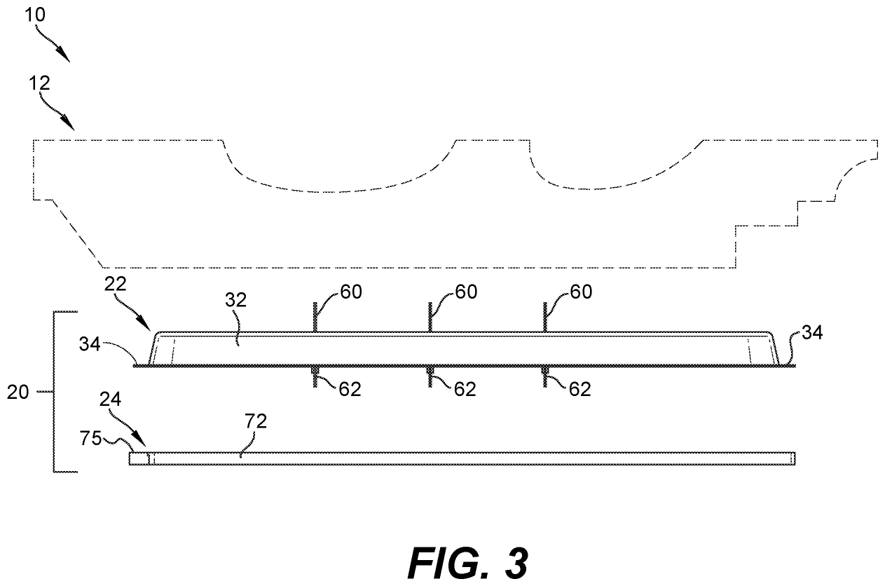

FIG. 3 shows an exploded side view of the BIW 10 with the integrated battery frame 20. Specifically, FIG. 3 shows details of the integrated cover 22 and the lower tray 24. As shown in FIG. 3, the integrated cover 22 includes several posts 60 extending upwardly from the upper panel 30 for mounting interior components (not shown), such as seats, trim components, heating/ventilation/air-conditioning (HVAC) components, etc. The integrated cover 22 also includes post supports 62 located opposite from corresponding ones of the posts 60 and extending downwardly to the lower tray 24 for distributing loads applied to the posts 60. It should be appreciated that the posts 60 are merely examples of structural supports, and the structural supports could take other forms, such as, for example, lugs, nuts, rods, etc.

FIG. 3 also shows some details of the lower tray 24, including a lower peripheral wall 72 and a tubular member 75. The lower tray 24 may be selectively attached to the integrated cover 24 using one or more fasteners, such as screws, nuts, bolts, pins, tabs, latches, etc., in order to enclose the battery compartment 14.

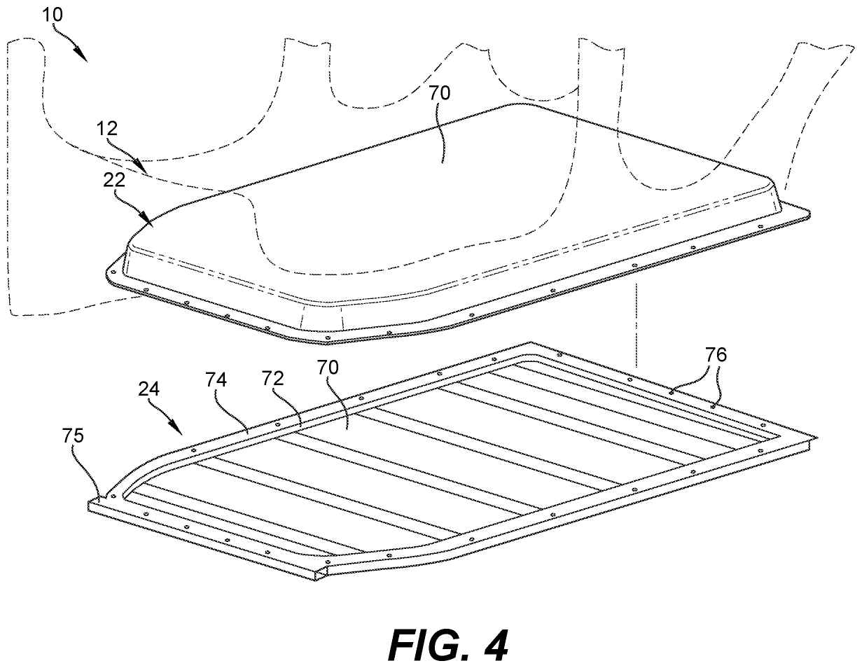

FIG. 4 is an exploded perspective view of the BIW 10 with the integrated battery frame 20. FIG. 4 shows additional details of the lower tray 24, including a lower panel 70 that extends parallel to the upper panel 30 of the integrated cover 22. The lower tray 24 also includes a lower peripheral wall 72 extending around the lower panel 70 and extending upwardly therefrom. A lower peripheral flange 74 extends outwardly from the lower peripheral wall 72 parallel to and spaced apart from the lower panel 70. The lower peripheral flange 74 defines a plurality of second mounting holes 76, which may be spaced apart from one another along the entirety of the lower peripheral flange 74. A tubular member 75 extends along at least one edge of the lower tray 24. In some embodiments, and as shown in FIG. 4, the tubular member 75 extends along a forward edge of the lower tray 24, outside of the lower peripheral wall 72. However, the lower tray 24 may include tubular members 75 along one or more other edges and/or around the entirety of the lower peripheral wall 72.

FIG. 5A is a cross-sectional view of the BIW with the integrated battery frame 20 in a disassembled configuration, which may be used, for example when installing a battery pack 16 therein. FIG. 5B is a cross-sectional view of the BIW with the integrated battery frame in an assembled configuration.

FIGS. 5A-5B show the tubular member 75 including a top hole 77 that is aligned with one of the second mounting holes 76 of the lower peripheral flange 74 for receiving a bolt 90 therethrough. The tubular member 75 also includes a lower hole 78 that may be larger than the top hole 77 and configured to provide access for installing the bolt 90 and a tool for turning the bolt 90. The tubular member 75 includes a protrusion 79 that extends outwardly from a lower surface thereof. The protrusion 79 may extend along a length of the tubular member and may be configured to be welded or otherwise attached to a lower surface of the lower panel 70 for securing the tubular member 75 with the lower panel 70 and the lower peripheral wall 72, which may be integrally formed from a single piece of material, such as metal.

The components 12 of the BIW 10 include a rocker panel 80, 82, 84, 86 that extends along a lower side of the vehicle. A similar rocker panel 80, 82, 84, 86 may extend along a lower edge of each side of the vehicle. The rocker panel 80, 82, 84, 86 includes a rocker floor 80, a lower wall 82, an inside wall 84, and a rocker upper 86. The rocker floor 80 extends in a horizontal plane to define a lower end of the rocker panel 80, 82, 84, 86. The lower wall 82 extends generally upwardly and inwardly from the rocker floor 80. The inside wall 84 extends vertically upwardly from above the lower wall 82, and the rocker upper 86 extends further upwardly and outwardly from the inside wall 84.

The integrated cover 22 is attached to the rocker panel 80, 82, 84, 86, with the upper peripheral flange 34 of the integrated cover 22 disposed along and adjacent to a lower surface of the rocker floor 80, and with the upper peripheral wall 32 of the integrated cover 22 disposed along an inner surface of the lower wall 82. A weld nut 88 is attached to an upper surface of the rocker floor 80 and is aligned with a corresponding one of the first mounting holes 36 for receiving a fastener, such as the bolt 90, and for holding the lower tray 24 to the integrated cover 22 and to the rocker panel 80, 82, 84, 86. It should be appreciated that other types of fasteners may be used, such as a screw or a nut that engages a bolt or a threaded stud in place of the weld nut 88.

A support rail 92 having an L-shaped cross-section includes a horizontal portion 93 and a vertical portion 94. The support rail 92 may be formed of a single piece of material, such as metal, that may be bent to form the L-shaped cross-section. The horizontal portion 93 of the support rail 92 overlies the upper panel 30 of the integrated cover 22 and extends outwardly beyond the upper peripheral wall 32 and is connected thereto, for example by welding. The vertical portion 94 of the support rail 92 extends along and abuts an inner surface of the inside wall 84 and is connected thereto, for example by welding. The support rail 92, therefore, further couples the integrated cover 22 to the rocker panel 80, 82, 84, 86, and provides a load path therebetween.

The lower tray 24 includes an internal tray 96 that extends parallel to and spaced apart from the lower panel 70, within the battery compartment 14. The internal tray 96 is configured to support the battery pack 16 and includes one or more ribs 97 to provide structural rigidity and/or to provide an air gap below the battery pack 16.

According to an aspect of the disclosure, the integrated battery frame 20 may provide the sole structural support between the two opposite rocker panels 80, 82, 84, 86 along all or substantially all of the length thereof. The integrated battery frame 20 may enclose the floor of the vehicle and may provide the required stiffness and strength to withstand operating loads and crash loads. The integrated battery frame 20 may provide mounting structures for attachment of vehicle interior components, such as passenger seats and trim components.

According to a further aspect of the disclosure, the integrated battery frame 20 may hold one or more battery packs 16 and ancillary equipment, such as battery cooling devices, conductors, and power electronic devices for managing charging and discharging of the battery packs 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The invention claimed is:

1. A body structure of a vehicle, comprising:
an integrated cover including an upper panel surrounded by an upper peripheral wall to define a battery compartment for holding a battery pack, the upper panel defining a floor of the vehicle; and
a lower tray selectively attached to the integrated cover to enclose the battery compartment and including a lower panel that extends parallel to the upper panel of the integrated cover.

2. The body structure of claim 1, further comprising a rocker panel extending along each of two opposite lower sides of the vehicle; and
wherein the integrated cover extends between the rocker panels of the vehicle from side to side, for providing a load path during crash events.

3. The body structure of claim 1, wherein the integrated cover is configured to support a seat within an interior of the vehicle.

4. The body structure of claim 3, wherein the integrated cover further comprises a plurality of structural supports attached to the upper panel for mounting the seat.

5. The body structure of claim 4, wherein the plurality of structural supports include posts extending upwardly from the upper panel.

6. The body structure of claim 4, wherein the integrated cover further comprises a plurality of post supports located opposite from corresponding ones of the plurality of structural supports and extending downwardly to the lower tray for distributing loads applied to the plurality of structural supports.

7. The body structure of claim 1, wherein the integrated cover further includes an upper peripheral wall surrounding at least a portion of the upper panel, and an upper peripheral flange extending outwardly from the upper peripheral wall parallel to and spaced apart from the upper panel;
wherein the lower tray further comprises a lower peripheral wall extending around at least a portion of the lower panel and extending upwardly therefrom, and lower peripheral flange extending outwardly from the lower peripheral wall; and
wherein the lower peripheral wall of the lower tray is configured to be secured parallel to and adjoining the upper peripheral wall of the integrated cover to enclose the battery compartment.

8. The body structure of claim 1, further comprising:
a rocker panel including a rocker floor extending in a horizontal plane, and a lower wall extending generally upwardly and inwardly from the rocker floor;
wherein the integrated cover further includes an upper peripheral wall surrounding at least a portion of the upper panel, and an upper peripheral flange extending outwardly from the upper peripheral wall parallel to and spaced apart from the upper panel; and
wherein the integrated cover is attached to the rocker panel with the upper peripheral flange of the integrated cover disposed along and adjacent to a lower surface of the rocker floor, and with the upper peripheral wall of the integrated cover disposed along an inner surface of the lower wall.

9. The body structure of claim 8, further comprising:
the upper peripheral flange of the integrated cover defining a first mounting hole; and
a weld nut attached to an upper surface of the rocker floor and aligned with the first mounting hole for receiving a fastener and for holding the lower tray to the integrated cover and to the rocker panel.

10. The body structure of claim 8, further comprising:
the rocker panel further including an inside wall that extends vertically upwardly from above the lower wall; and
a support rail attached to each of the inside wall of the rocker panel and to the integrated cover to couple the rocker panel with the integrated cover and to provide a load path therebetween.

11. The body structure of claim 10, wherein the support rail has an L-shaped cross-section including a horizontal portion and a vertical portion, the horizontal portion of the support rail overlying the upper panel of the integrated cover and connected thereto, and the vertical portion of the support rail extending along and abutting an inner surface of the inside wall and connected thereto.

12. The body structure of claim 1, wherein the lower tray further comprises a tubular member extending along at least one edge thereof.

13. The body structure of claim 12, wherein the tubular member includes a protrusion that extends outwardly from a lower surface thereof and attached to a lower surface of the lower panel for securing the tubular member to the lower panel of the lower tray.

14. The body structure of claim 1, wherein the integrated cover further includes an upper peripheral wall surrounding at least a portion of the upper panel, and an upper peripheral flange extending outwardly from the upper peripheral wall parallel to and spaced apart from the upper panel;
wherein the upper peripheral flange of the integrated cover defines a first mounting hole;
wherein the lower tray further includes a lower peripheral wall extending around at least a portion of the lower panel and extending upwardly therefrom, and a lower peripheral flange extending outwardly from the lower peripheral wall parallel to and spaced apart from the lower panel; and
wherein the lower peripheral flange defines a second mounting hole that is aligned with the first mounting hole of the upper peripheral flange for receiving a fastener through each of the first mounting hole and the second mounting hole for holding the lower tray to the integrated cover.

15. A battery frame for a vehicle, comprising:
an integrated cover including an upper panel surrounded by an upper peripheral wall to define a battery compartment for holding a battery pack;
a lower tray selectively attached to the integrated cover to enclose the battery compartment and including a lower panel that extends parallel to the upper panel of the integrated cover; and
wherein the upper panel of the integrated cover is configured to connect to and span between each of two opposite rocker panels of the vehicle and to provide a load path therebetween.

16. The battery frame of claim 15, wherein the upper panel defines a floor of the vehicle.

17. The battery frame of claim 15, wherein at least one rocker panel of the two opposite rocker panels each includes a rocker floor extending in a horizontal plane, and a lower wall extending generally upwardly and inwardly from the rocker floor,
wherein the integrated cover further includes an upper peripheral wall surrounding at least a portion of the upper panel, and an upper peripheral flange extending outwardly from the upper peripheral wall parallel to and spaced apart from the upper panel,
wherein the upper peripheral flange of the integrated cover is disposed along and adjacent to a lower surface of the rocker floor of the at least one rocker panel, and
wherein the upper peripheral wall of the integrated cover is disposed along an inner surface of the lower wall of the at least one rocker panel.

18. The battery frame of claim 17, wherein the upper peripheral flange of the integrated cover defines a first mounting hole; and
wherein the battery frame further includes a weld nut attached to an upper surface of the rocker floor and aligned with the first mounting hole for receiving a fastener and for holding the lower tray to the integrated cover and to the rocker panel.

19. The battery frame of claim 15, wherein the integrated cover further comprises a plurality of structural supports attached to the upper panel for supporting a seat located within an interior of the vehicle.

20. The body structure of claim 1, wherein the integrated cover encloses the battery compartment for protecting batteries disposed therein from water intrusion.
